(19) United States
(12) Patent Application Publication
(10) Pub. No.: US 2010/0300140 A1
(43) Pub. Date: Dec. 2, 2010

(54) Air Conditioning System for Cooling the Cabin of a Hybrid-Electric Vehicle

(75) Inventors: Lindsey L. Leitzel, Lockport, NY (US); Edward Wolfe, IV, E. Amherst, NY (US); Willliam J. Kumpf, Lockport, NY (US); James A. Bright, Gasport, NY (US)

Correspondence Address: DELPHI TECHNOLOGIES, INC, M/C 480-410-202, PO BOX 5052, TROY, MI, 48007, US

(73) Assignee: DELPHI TECHNOLOGIES, INC., Troy, MI (US)

(21) Appl. No.: 12/473,664

(22) Filed: May 28, 2009

(51) Int. Cl. F25B 1/00; B60K 6/20

(52) U.S. Cl. 62/498; 180/65.21

(57) ABSTRACT

An air conditioning system for use in a hybrid-electric vehicle having an engine and a cabin. The system includes a refrigerant loop and a coolant loop. A phase change heat exchanger including a first tube in fluid communication with the refrigerant loop and a second tube in fluid communication with the coolant loop. The first and second tubes abut one another for conducting heat from the coolant in the coolant loop to the first refrigerant in the refrigerant loop when the vehicle is operating with the engine running. The phase change heat exchanger further includes a chamber abutting the first and second tubes for storing a phase change material. The phase change material conducts heat to the first refrigerant to freeze the phase change material when the vehicle is operating with the engine running and receives heat from the coolant to cool the coolant when the engine is not running.

### BACKGROUND OF THE INVENTION

1. Field of the Invention

An air conditioning system for cooling the cabin of a hybrid-electric vehicle.

2. Description of the Prior Art

In general, fuel efficiency in hybrid-electric vehicles is enhanced by shutting off the gasoline engine during inefficient periods, such as when the vehicle is coasting or temporarily stopped. The compressor of a traditional air conditioning system runs off the crankshaft of the gasoline engine, and therefore is inoperative when the gasoline engine is shut off during those inefficient periods. Such a traditional air conditioning system is undesireable for hybrid-electric vehicles because it may lead to uncomfortable conditions for the vehicle's passengers during those times when the engine is not running.

U.S. Pat. No. 7,147,071 to Gering et al. (hereinafter referred to as Gering '071) discloses a thermal management system for hybrid-electric vehicles. The Gering '071 system includes a refrigerant loop for cycling a refrigerant and a coolant loop for cycling a coolant. The system further includes a phase change heat exchanger having a first tube in fluid communication with the refrigerant loop and a second tube in fluid communication with the coolant loop. The first tube in the phase change heat exchanger abuts the second tube for transferring heat from the first refrigerant to the coolant in the first and second tubes. The phase change heat exchanger further includes a chamber for storing a phase change material. The chamber abuts the first and second tubes for receiving heat from the refrigerant in the first tube when the engine is running and transferring heat to the coolant in the second tube when the engine is not running.

The Gering '071 patent shows a system that includes a coolant loop that continues to function after the vehicle's engine has shut off, but it functions to warm the vehicle's battery and does nothing to cool the passenger compartment of the vehicle.

### SUMMARY OF THE INVENTION

The invention provides for such a thermal management system and wherein the chamber abuts the first tube and the second tube for conducting heat from the coolant in the second tube to the refrigerant in the first tube to cool the coolant in a first operating mode and for conducting heat from the coolant in the second tube to the phase change material in the chamber to cool the coolant in a second operating mode.

The cooled coolant is used to cool the cabin of the hybrid-electric vehicle. The system of the subject invention continues to function for a period of time after the engine of the vehicle stops, thereby providing comfortable temperatures for the occupants in the cabin of the vehicle without compromising the vehicle's fuel economy. During the first operating mode (when the engine of the vehicle is running), the refrigerant in the refrigerant loop receives heat from the phase change material in the chamber to freeze the phase change material. During the second operating mode (when the engine of the vehicle temporarily shuts off), e.g. when the vehicle is coasting or temporarily stopped, the coolant in the coolant loop transfers heat to the frozen phase change material to cool the coolant. This cooled coolant then is used to cool the cabin of the vehicle. Additionally, the refrigerant loop of such a system may be kept under the hood of the vehicle and away from the cabin while the coolant loop is then used to cool the flow of air into the cabin of the vehicle. Where an efficient, but dangerous fluid is used as the first refrigerant, the chance of it coming in contact with the occupants in the cabin is minimized when compared to the conventional air conditioning systems. A safer fluid can be used as the coolant, e.g. water and glycol (more often referred to as anti-freeze).

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a schematic of an air conditioning system according to the present invention; and

FIG. 2 is a perspective and fragmentary view of the phase change heat exchanger according to the present invention.

### DETAILED DESCRIPTION OF THE EXEMPLARY EMBODIMENT

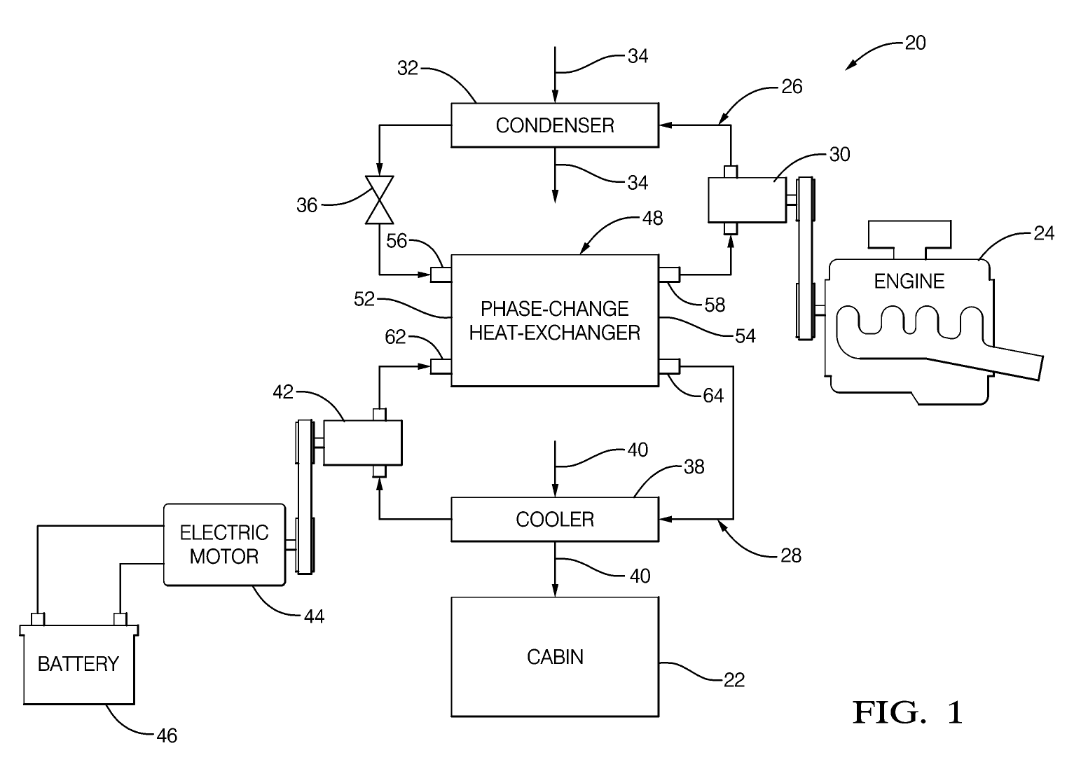

Referring to the Figures, wherein like numerals indicate corresponding parts throughout the several views, an air conditioning system 20 for cooling the cabin 22 of a hybrid-electric vehicle having an engine 24 is generally shown in FIG. 1. The hybrid-electric vehicle has a first operating mode where the engine 24 is running and a second operating mode where the engine 24 is not running. The air conditioning system 20 includes a refrigerant loop 26, generally indicated, for cycling a refrigerant and includes a coolant loop 28, generally indicated, for cycling a coolant.

The refrigerant loop 26 includes a compressor 30 for compressing the refrigerant to a superheated gas. The compressor 30 is operably connected to the engine 24 of the vehicle. In other words, the compressor 30 can only operate while the vehicle's engine 24 is running, or in the first operating mode. The refrigerant loop 26 further includes a condenser 32 in fluid communication with the compressor 30 for receiving the superheated refrigerant and for transferring heat from the superheated refrigerant to a first flow of air 34 to condense the gaseous refrigerant to a liquid. The refrigerant loop 26 further includes an expansion valve 36 in fluid communication with the condenser 32 for receiving the liquid refrigerant and for subcooling the liquid refrigerant.

The coolant loop 28 includes a cooler 38 for transferring heat from a second flow of air 40 in fluid communication with the cabin 22 of the vehicle to the coolant to cool the second flow of air 40 and warm the coolant. In other words, heat is transferred from the second flow of air 40, which is used to cool the cabin 22 of the vehicle, to the coolant in the coolant loop 28. A pump 42 is in fluid communication with the cooler 38 for receiving the warm coolant and for cycling the coolant through the coolant loop 28. In the preferred embodiment, the pump 42 is operably connected to an electric motor 44 that is powered by the vehicle's battery 46. The pump 42, therefore, cycles the coolant through the coolant loop 28 with regardless of whether the engine 24 is running or shut off, i.e. in both the first and second operating modes.

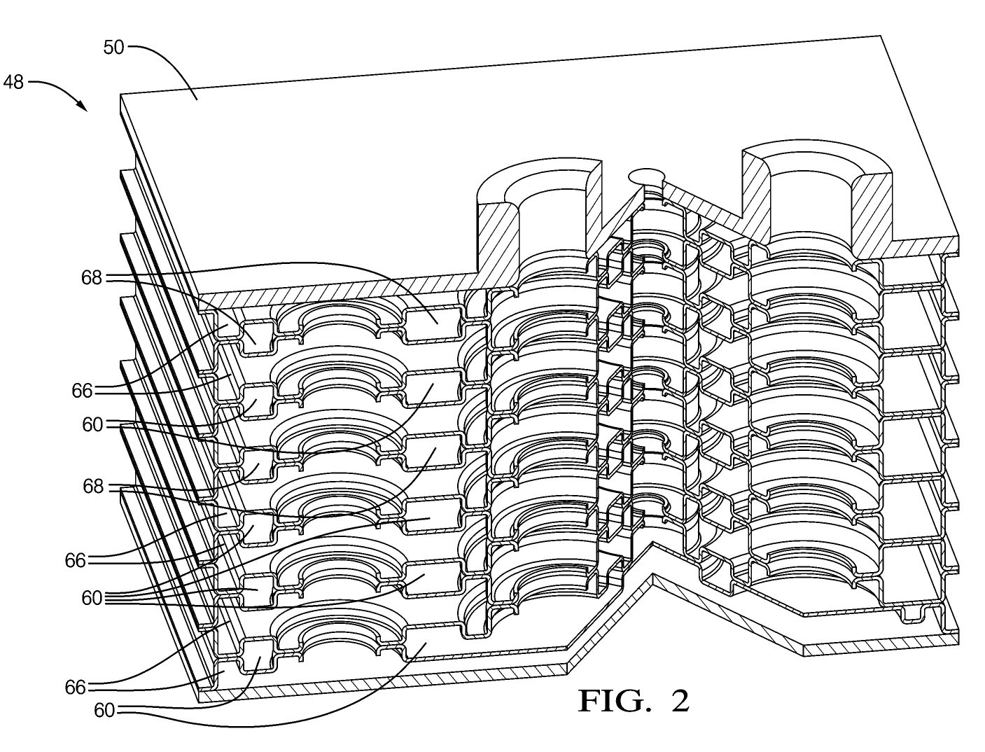

Completing the refrigerant and coolant loops 26, 28 is a unified phase change heat exchanger 48 (generally indicated in FIG. 1 and generally shown in FIG. 2). The phase change heat exchanger 48 is in fluid communication with the refrigerant loop 26 and with the coolant loop 28 for transferring heat from the coolant in the coolant loop 28 to the first refrigerant in the refrigerant loop 26 to evaporate the first refrigerant to a gas and to cool the coolant while the vehicle is operating with the engine 24 on.

The phase change heat exchanger 48 includes a housing 50 having a first side 52 and a second side 54. The first side 52 of the housing 50 defines a first input 56 for receiving the subcooled liquid refrigerant from the expansion valve 36 in the refrigerant loop 26 and the second side 54 of the housing 50 defines a first output 58 for dispensing the gaseous refrigerant to the condenser 32 in the refrigerant loop 26. At least one first tube 60 is disposed in the housing 50 of the phase change heat exchanger 48 and extends between the first input 56 and the first output 58 for conveying the refrigerant therebetween.

The first side 52 of the housing 50 further defines a second input 62 for receiving the warm coolant from the pump 42 in the coolant loop 28, and the second side 54 of the housing 50 further defines a second output 64 for dispensing the cooled coolant to the second cooler 38 in the coolant loop 28. At least one second tube 66 is disposed in the housing 50 of the phase change heat exchanger 48 and extends between the second input 62 and the second output 64 with each of the second tubes 66 abutting at least one of the first tubes 60 for conducting heat from the coolant in the second tubes 66 to the refrigerant in the first tubes 60. As shown in FIG. 2, the first and second tubes 60, 66 can be passages having separators disposed between adjacent passages.

The housing 50 of the phase change heat exchanger 48 defines at least one chamber 68 for storing a phase change material. Each chamber 68 abuts at least one of the first tubes 60 for conducting heat to the first refrigerant in the first tubes 60 when the vehicle is operating with the engine 24 on to cool and/or freeze the phase change material. Each chamber 68 further abuts at least one of the second tubes 66 for conducting heat from the coolant in the second tubes 66 to the frozen (or cooled) phase change material when the vehicle is operating with the engine 24 off.

In the preferred embodiment, each of the chambers 68 is disposed closer to the first and second outputs 58, 64 on the second side 54 of the housing 50 of the phase change heat exchanger 48 than to the inputs 56, 62 on the first side 52 of the housing 50 of the phase change heat exchanger 48. This ensures maximum performance by only transferring heat from the phase change material to the refrigerant in the refrigerant loop 26 when there is extra capacity to absorb that heat. In other words, while the engine 24 of the vehicle is running, the maximum heat transfer in the phase change heat exchanger 48 occurs between the coolant in the coolant loop 28 and the refrigerant in the refrigerant loop 26. The phase change material in the chambers 68 only transfers heat to any extra capacity refrigerant has after absorbing heat from the coolant.

The housing 50 of the phase change heat exchange preferably is made of an insulating material or has an insulating material disposed in it to prevent heat from being dissipated from the phase change material in the chambers 68 to the ambient air, which would decrease the efficiency of the system.

In the preferred embodiment, the refrigerant in the refrigerant loop 26 is R-134a, the coolant is a mixture of water and glycol, and the phase change material is water.

In operation, the air conditioning system 20 of the present invention is an improved system that can keep the cabin 22 of a hybrid-electric vehicle cool for a period of time even after the engine 24 of the car has turned off. When the engine 24 of the vehicle is running, the coolant in the coolant loop 28 and the phase change material in the chambers 68 simultaneously transfer heat to the refrigerant in the refrigerant loop 26, thus cooling the coolant and cooling and/or freezing the phase change material. When the vehicle is either coasting or temporarily stopped, engine 24 stops running, and thus, the refrigerant loop 26 shuts down. However, pump 42 continues to circulate the coolant through the coolant loop 28, the coolant continues to transfer heat to the cold/frozen phase change material to warm/melt the phase change material. The cooled coolant receives heat from the second flow of air 40, which is directed at the cabin 22 of the vehicle. The air conditioning system 20 continues functioning and keeps the cabin 22 of the vehicle at a comfortable temperature for a period of time after the engine 24 has stopped running. Such a system is also beneficial because it acts passively and does not require a controller to function.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An air conditioning system having comprising:
a refrigerant loop for cycling a refrigerant and a coolant loop for cycling a coolant;
a phase change heat exchanger including a first tube in fluid communication with said refrigerant loop and a second tube in fluid communication with said coolant loop;
said first tube abutting said second tube for conducting heat from said coolant in said coolant loop to said refrigerant in said refrigerant loop to cool said coolant in a first operating mode;
said phase change heat exchanger defining a chamber abutting said first and second tubes for storing a phase change material;
said chamber abutting said first tube and said second tube for conducting heat from said phase change material in said chamber to said refrigerant in said first tube to freeze said phase change material in the first operating mode and for conducting heat from said coolant in said second tube to said phase change material in said chamber to cool said coolant in a second operating mode.

2. The air conditioning system as set forth in claim 1 wherein said phase change heat exchanger has a housing.

3. The air conditioning system as set forth in claim 2 wherein said housing of said phase change heat exchanger has a first side defining a first input for receiving said refrigerant as a liquid from said refrigerant loop and a second side defining a first output for dispensing said refrigerant as a gas to said refrigerant loop.

4. The air conditioning system as set forth in claim 3 wherein said first tube extends between said first input and said first output for conveying said refrigerant therebetween.

5. The air conditioning system as set forth in claim 4 further including a plurality of first tubes.

6. The air conditioning system as set forth in claim 3 wherein said first side of said housing of said phase change heat exchanger further defines a second input for receiving said coolant from said coolant loop and said second side of said housing of said heat exchanger further defines a second output for dispensing said cooled coolant to said coolant loop.

7. The air conditioning system as set forth in claim 6 wherein said second tube extends between said second input and said second output for conveying said coolant therebetween.

8. The air conditioning system as set forth in claim 7 further including a plurality of second tubes.

9. The assembly as set forth in claim 6 wherein said chamber is disposed closer to said first and second outputs on said second side of said housing of said phase change heat exchanger than to said first and second inputs on said first side of said housing of said phase change heat exchanger.

10. The assembly as set forth in claim 9 further including a plurality of chambers.

11. The air conditioning system as set forth in claim 1 wherein said air conditioning system is disposed in a hybrid-electric vehicle having an engine and a cabin.

12. The air conditioning system as set forth in claim 11 wherein said first operating mode is with the engine of the vehicle running and said second operating mode is with the engine of the vehicle not running.

13. The assembly as set forth in claim 11 further including a compressor in said refrigerant loop for compressing said refrigerant to a superheated gas.

14. The assembly as set forth in claim 13 wherein said compressor is operably connected to the engine of the vehicle.

15. The assembly as set forth in claim 13 further including a condenser in said refrigerant loop in fluid communication with said compressor for receiving said superheated refrigerant and for transferring heat from said refrigerant to a first flow of air to condense said gaseous refrigerant to a liquid.

16. The assembly as set forth in claim 15 further including an expansion valve in said refrigerant loop in fluid communication with said condenser for receiving said liquid refrigerant and for subcooling said liquid refrigerant.

17. The assembly as set forth in claim 1 further including a cooler in said coolant loop in fluid communication with said phase change heat exchanger for receiving said cooled coolant and for transferring heat from a second flow of air to said coolant to cool the second flow of air and to warm said coolant.

18. The assembly as set forth in claim 17 wherein the second flow of air is in fluid communication with a cabin of a vehicle.

19. The assembly as set forth in claim 17 further comprising a pump in said coolant loop in fluid communication with said cooler for receiving said warm coolant and for cycling said coolant through said coolant loop in the first and second operating modes.

20. The assembly as set forth in claim 19 wherein said pump is operably connected to an electric motor for continuing to compress said coolant to a superheated gas when the engine of the vehicle is not running.

21. The assembly as set forth in claim 1 wherein said refrigerant is R-134a.

22. The assembly as set forth in claim 1 wherein said coolant is a mixture of water and glycol.

23. The assembly as set forth in claim 1 wherein said phase change material is water.

24. An air conditioning system for cooling the cabin of a hybrid-electric vehicle having an engine and a cabin comprising:
a refrigerant loop for cycling a refrigerant and a coolant loop for cycling a liquid coolant;
a compressor in said refrigerant loop for compressing said refrigerant to a superheated gas;
said compressor being operably connected to the engine of the vehicle;
a condenser in said refrigerant loop in fluid communication with said compressor for receiving said superheated refrigerant and for transferring heat to a first flow of air to condense said refrigerant to a liquid;
an expansion valve in said refrigerant loop in fluid communication with said condenser for receiving said liquid refrigerant and for subcooling said refrigerant;
a cooler in said coolant loop for receiving said coolant and for transferring heat from a second flow of air in fluid communication with the cabin of the vehicle to said coolant to cool the second flow of air and to warm said coolant;
a pump in said coolant loop in fluid communication with said cooler for receiving said warm coolant and for cycling said coolant through said coolant loop;
said pump being operably connected to an electric motor for continuing to cycle said coolant when the vehicle is operating with the engine off;
a phase change heat exchanger in fluid communication with said refrigerant loop and with said coolant loop for transferring heat from said coolant in said coolant loop to said refrigerant in said refrigerant loop to evaporate said refrigerant to a gas and to cool said liquid coolant when the vehicle is operating with the engine running;
said phase change heat exchanger including a housing being of an insulating material and having a first side and a second side;
said first side of said housing defining a first input for receiving said subcooled liquid refrigerant from said expansion valve in said refrigerant loop and said second side of said housing defining a first output for dispensing said gaseous first refrigerant to said condenser in said refrigerant loop;
at least one first tube disposed in said housing of said phase change heat exchanger and extending between said first input and said first output for conveying said refrigerant therebetween;
said first side of said housing defining a second input for receiving said warm coolant from said pump in said coolant loop and said second side of said housing defining a second output for dispensing said cooled coolant to said cooler in said coolant loop;
at least one second tube disposed in said housing of said phase change heat exchanger and extending between said second input and said second output with each of said second tubes abutting at least one of said first tubes for allowing heat conduction from said coolant in said coolant loop to said refrigerant in said refrigerant loop;
said housing of said phase change heat exchanger defining at least one chamber for storing a phase change material;
each of said chambers abutting at least one of said first tubes and at least one of said second tubes for transferring heat from said phase change material in said chambers to said refrigerant in said first tubes when the vehicle is operating with the engine on to freeze said phase change material and for receiving heat from said coolant in said second tubes to cool said coolant when the engine of the vehicle is not running;
each of said chambers being disposed closer to said first and second outputs on said second side of said housing of said phase change heat exchanger than to said first and second inputs on said first side of said housing of said phase change heat exchanger;
said refrigerant being further defined as R-134a;
said coolant being further defined as a mixture of water and glycol; and
said phase change material being further defined as water.
